(19) United States
(12) Patent Application Publication
(10) Pub. No.: US 2011/0249784 A1
(43) Pub. Date: Oct. 13, 2011

(54) DRIVING SYSTEM OF RELIEF SAFETY VALVE

(75) Inventors: Hiroshi Yamazaki, Yokohama-Shi (JP); Mikihide Nakamaru, Fujisawa-Shi (JP); Kazuhiro Kamei, Yokohama-Shi (JP)

(73) Assignee: KABUSHIKI KAISHA TOSHIBA, Tokyo (JP)

(21) Appl. No.: 13/080,303

(22) Filed: Apr. 5, 2011

(30) Foreign Application Priority Data
Apr. 9, 2010 (JP) 2010-090091

(51) Int. Cl. G21C 9/004

(52) U.S. Cl. 376/283

(57) ABSTRACT

In one embodiment a relief safety valve driving system that supplies a driving gas by use of a relief safety valve driving unit and thereby opens a relief safety valve provided in a main steam system of a nuclear power plant if an accident or a transient state occurs, for protecting a reactor against pressurization, wherein the relief safety valve driving unit opens the relief safety valve by supplying the driving gas to the relief safety valve by one or more auto-depressurization system actuating signals, among auto-depressurization system actuating signals respectively belonging to three safety segments, or by a relief valve functions actuating signal, and closes the relief safety valve without supplying the driving gas thereto when none of the auto-depressurization system actuating signals and the relief valve functions actuating signal is generated.

### CROSS-REFERENCE TO RELATED APPLICATIONS

This application is based upon and claims the benefit of priority from Japanese Patient application No. 2010-090091, filed on Apr. 9, 2010, the entire contents of each of which are incorporated herein by reference.

### FIELD

Embodiments described herein relate generally to a relief safety valve driving system for protecting a reactor against pressurization, if an accident or a transient state occurs, by opening a relief safety valve provided in a main steam system of a nuclear power plant by use of a driving gas supplied from a relief safety valve driving unit.

### BACKGROUND

A relief safety valve applied to boiling-water and other types of nuclear power plants is a piece of equipment for constituting a main steam system. This main steam system comprises a main steam pipeline, a relief safety valve, a main steam flow restrictor, a main steam isolation valve and a main steam pipe drain system. Functions of the main steam system include supplying steam from a reactor pressure vessel to a turbine, controlling the pressure of the reactor pressure vessel to within limit values in a transient state of a reactor, and restricting the release of steam from the reactor pressure vessel and a reactor containment vessel (see, for example, Japanese Patent Laid-Open No. 9-304584).

FIG. 13 illustrates a reactor containment vessel of a boiling-water nuclear power plant, whereas FIG. 14 is an enlarged view of a pressure suppression pool illustrated in FIG. 13. As illustrated in FIGS. 13 and 14, a reactor pressure vessel 2 is placed within a reactor containment vessel 1, and a relief safety valve 5 is mounted on a main steam pipeline 3 of a main steam system. A relief safety valve exhaust pipe 6 for guiding steam to a pressure suppression pool 4 of the reactor containment vessel 1 is connected to this relief safety valve 5. A vent pipe 7 is installed in a wall of the pressure suppression pool 4. A quencher 8 for facilitating the condensation of steam within the pressure suppression pool 4 is connected to a lower end of the relief safety valve exhaust pipe 6. Note that reference characters 9A and 9B in FIG. 13 denote main steam isolation valves.

The main steam system is generally provided with a plurality of main steam pipelines 3 for guiding steam generated within the reactor pressure vessel 2 to a turbine. A plurality of relief safety valves 5 is mounted on each main steam pipeline 3. Each relief safety valve 5 is located in part of each main steam pipeline 3 within the reactor containment vessel 1, in order to suppress reactor pressure to below a specified value if, for some reason, an accident or the like occurs in a reactor or in the vicinity thereof. Each relief safety valve 5 has spring-operated safety functions and relief valve functions for opening operation of the relief safety valve by an auxiliary actuator at a blowout pressure setpoint or lower.

The relief valve functions are designed to release steam within the reactor pressure vessel 2 to the pressure suppression pool 4 by means of manual opening operation or automatic opening operation in response to a high relief valve pressure setpoint. In addition, auto-depressurization system functions to be enabled in case of a loss-of-coolant accident are built into some of the relief safety valves 5. The auto-depressurization system functions cause the relief safety valves 5 to automatically open if a reactor containment vessel 1 pressure “high” and reactor water level “low” signal is generated while a residual heat removal system pump or a high-pressure core water injection system pump is in operation, thereby lowering the internal pressure of the reactor pressure vessel 2. Thus, a reactor core is fully cooled by the residual heat removal system pump or the high-pressure core water injection system pump.

FIG. 15 illustrates a configuration of each relief safety valve 5. The relief safety valve 5 is a driving gas (for example, nitrogen gas)-operated and spring-operated valve. The relief safety valve 5 is mounted on a pipe base (not illustrated) provided on each main steam pipeline 3 within the reactor containment vessel 1. A valve outlet 10 is a flange and connected to the relief safety valve exhaust pipe 6. The relief safety valve 5 is adapted to automatically open (safety functions) if the pressure of a valve inlet 11 exceeds the set loads of springs 12 and 19. In addition, a piston 14 and a valve rod 15 within an air cylinder 13 mounted on a valve body are coupled with each other by a pull-up lever 16. When the driving gas is supplied into the air cylinder 13, the piston 14 moves and the pull-up lever 16 rotates around a fulcrum 17. Consequently, a valve element 18 fitted on a leading end of the valve rod 15 is pulled up, and therefore, the relief safety valve 5 opens. The driving gas is supplied to the air cylinder 13 by a relief safety valve driving unit 25 (FIG. 16) to be described later.

Next, a description will be given of the operating logic of the relief safety valve 5. FIG. 16 illustrates a conventional relief safety valve driving system. It should be noted that unless otherwise specified, a plant is in a normal operating condition in which neither auto-depressurization system actuating signals A(I) and A(II) nor a relief valve functions actuating signal B are generated. At this time, the relief safety valve 5 is in a standby state.

As illustrated in FIG. 16, if an accident or a transient state occurs, a high-pressure nitrogen gas is supplied from an auto-depressurization system driving gas supply system 21 and a relief valve functions driving gas supply system 22 to open the relief safety valve 5. In the auto-depressurization system driving gas supply system 21 and relief valve functions driving gas supply system 22, an accumulator 23 for auto-depressurization functions and an accumulator 24 for relief valve functions are provided in their respective driving gas supply systems 21 and 22, so that a supply of the driving gas is possible for a period and a frequency prescribed for safety reasons even in case of loss of functions.

Upon generation of a reactor water level “low” and reactor containment vessel (dry well) pressure “high” simultaneous signal, the auto-depressurization system actuating signals A(I) and A(II) are generated with an emergency core cooling system pump (the residual heat removal system pump or the high-pressure core water injection system pump) enabled. On the basis of these auto-depressurization system actuating signals A(I) and A(II), one of two three-way solenoid valves for auto-depressurization functions 26(I) and 26(II) of the relief safety valve driving unit 25 is excited. Then, the driving gas is supplied from the auto-depressurization system-specific driving gas supply system 21 or the accumulator 23 through a driving gas supply line 28, thereby opening the relief safety valve 5. Consequently, steam from the main steam pipeline 3 flows to the pressure suppression pool 4, as shown by arrows S1 and S2. Thus, the internal pressure of the reactor pressure vessel 2 lowers.

Note that the driving gas for driving the relief safety valve 5 is generally a nitrogen gas. The gas is supplied from an unillustrated high-pressure nitrogen gas supply system to the auto-depressurization system-specific driving gas supply system 21 and the relief valve functions driving gas supply system 22. Also note that roman numerals I and II denote types of safety segments.

On the other hand, if a reactor pressure rises and then a relief valve pressure setpoint “high” signal 30 is generated by a pressure gauge for relief valve functions 29 or a manual opening operation signal 31 is generated, a relief valve functions actuating signal B is generated. On the basis of this relief valve functions actuating signal B, one three-way solenoid valve for relief valve functions 27 of the relief safety valve driving unit 25 is excited. Then, the driving gas is supplied from the relief valve functions driving gas supply system 22 or the accumulator 24 through the driving gas supply line 28, thereby opening the relief safety valve 5. Consequently, steam within the main steam pipeline 3 flows out into the pressure suppression pool 4 in the same way as described above. Thus, the internal pressure of the reactor pressure vessel 2 lowers.

Note that reference numeral 32 in FIG. 16 denotes the reactor containment vessel side, reference numeral 33 denotes the reactor building side, and reference numeral 34 denotes a containment vessel isolation valve. In addition, reference numeral 35 denotes a containment vessel penetrating part for piping and reference numeral 36 denotes a containment vessel penetrating part for cabling.

As described above, even if one of the two solenoid valves for auto-depressurization functions 26(I) and 26(II) respectively belonging to different safety segments fails, operation required of a solenoid valve for auto-depressurization functions is still possible. In recent years, however, maintenance during plant operation (i.e., online maintenance) is carried out in some cases, in order to improve the availability factor of a nuclear power plant. In this case, there is only one remaining safety segment in a current configuration, if one safety segment of a power supply system is shut down at the time of, for example, online maintenance. Accordingly, there is the possibility of failing to satisfy single-failure criteria in which if one system or one piece of equipment falls into operational failure, safety is ensured by putting another system or piece of equipment into operation.

The present invention has been accomplished in view of the above-described circumstances, and an object of the invention is to provide a relief safety valve driving system compatible with online maintenance for each safety segment and capable of improving the availability factor of a nuclear power plant.

### BRIEF DESCRIPTION OF THE DRAWINGS

FIG. 1 is a system configuration diagram illustrating a first embodiment of a relief safety valve driving system according to the present invention;

FIG. 2 is a schematic cross-sectional view illustrating an unexcited state of a relief safety valve driving unit in FIG. 1;

FIG. 3 is a schematic cross-sectional view illustrating an excited state of the relief safety valve driving unit in FIG. 2;

FIG. 4 is a system configuration diagram illustrating a second embodiment of the relief safety valve driving system according to the present invention;

FIG. 5 is a system configuration diagram illustrating a modified embodiment of the relief safety valve driving system of FIG. 4;

FIG. 6 is a system configuration diagram illustrating a third embodiment of the relief safety valve driving system according to the present invention;

FIG. 7 is a system configuration diagram illustrating a fourth embodiment of the relief safety valve driving system according to the present invention;

FIG. 8 is a system configuration diagram illustrating a fifth embodiment of the relief safety valve driving system according to the present invention;

FIG. 9 is a system configuration diagram illustrating a modified embodiment of the relief safety valve driving system of FIG. 8;

FIG. 10 is a system configuration diagram illustrating a sixth embodiment of the relief safety valve driving system according to the present invention;

FIG. 11 is a system configuration diagram illustrating a modified embodiment of the relief safety valve driving system of FIG. 10;

FIG. 12 is a system configuration diagram illustrating another modified embodiment of the relief safety valve driving system of FIG. 10;

FIG. 13 is a configuration diagram illustrating a conventional reactor containment vessel;

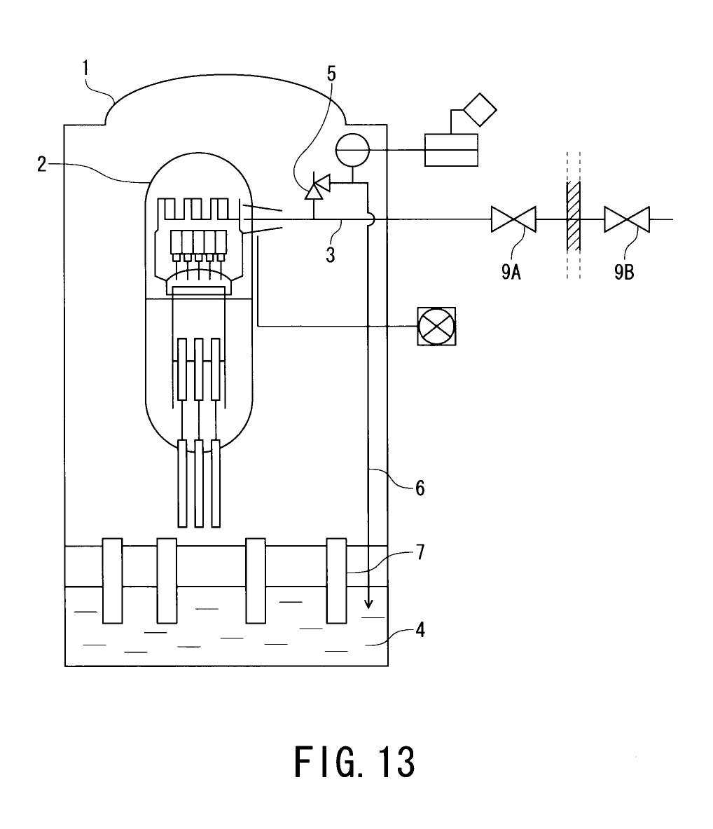

FIG. 14 is a cross-sectional view illustrating a pressure suppression pool in FIG. 1;

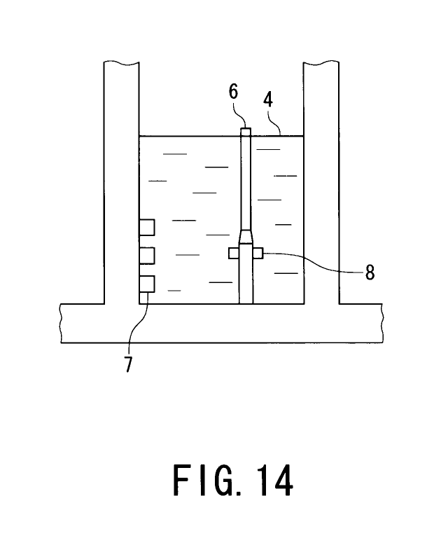

FIG. 15 is a cross-sectional view illustrating a relief safety valve in FIG. 13; and

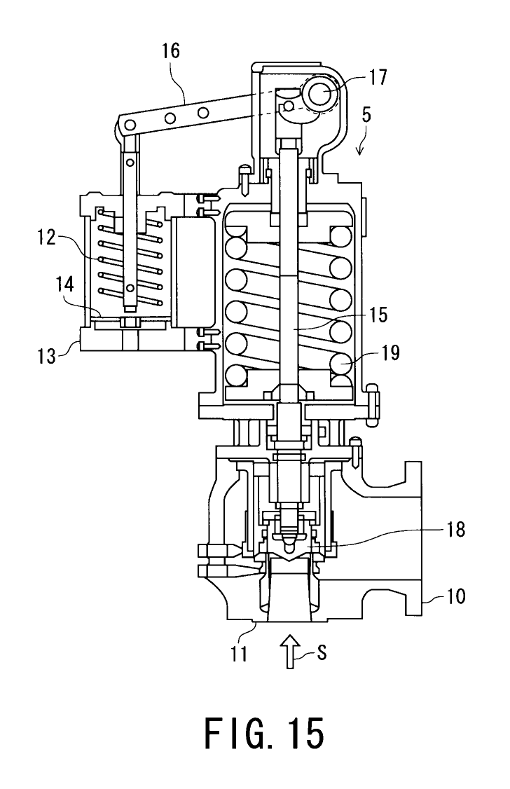

FIG. 16 is a system configuration diagram illustrating a conventional relief safety valve driving system.

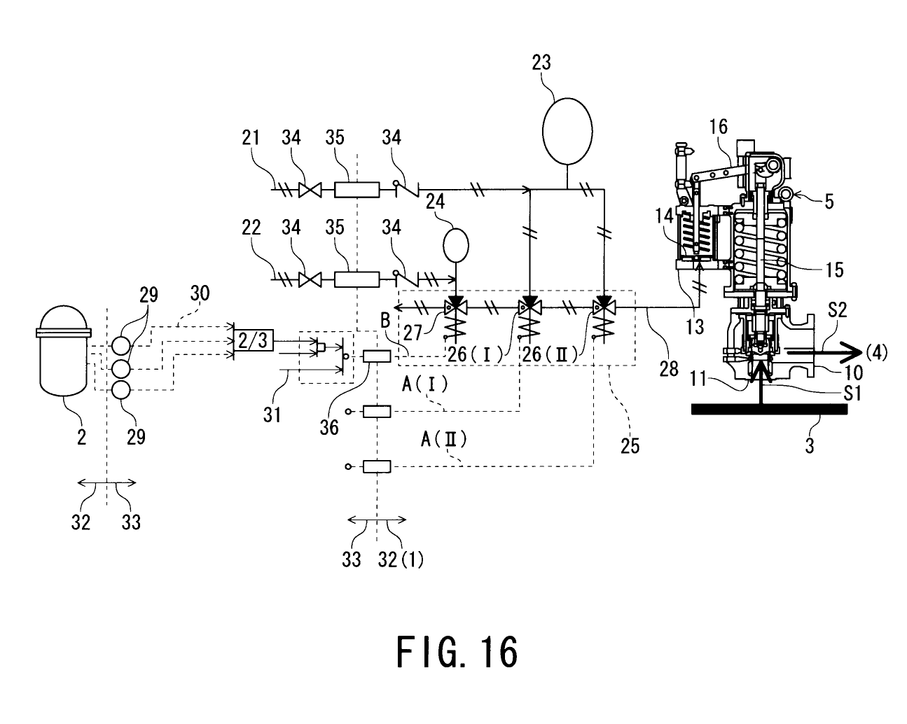

### DETAILED DESCRIPTION

Hereinafter, best modes for carrying out the present invention will be described according to the accompanying drawings. Note however that the present invention is not limited to these embodiments. For example, though in each of the below-described embodiments, a description will be given of a case in which the present invention is applied to a boiling-water reactor, the present invention is also applicable to reactors other than boiling-water reactors.

In one embodiment, a relief safety valve driving system 40 that supplies a driving gas by use of a relief safety valve driving unit 41 and thereby opens a relief safety valve 5 provided in a main steam system of a nuclear power plant if an accident or a transient state occurs, for protecting a reactor against pressurization, wherein the relief safety valve driving unit 41 opens the relief safety valve 5 by supplying the driving gas to the relief safety valve 5 by one or more auto-depressurization system actuating signals A(I), A(II) and A(III), among auto-depressurization system actuating signals A(I), A(II) and A(III) respectively belonging to three safety segments I, II and III, or by a relief valve functions actuating signal B, and closes the relief safety valve 5 without supplying the driving gas thereto when none of the auto-depressurization system actuating signals A(I), A(II) and A(III) and the relief valve functions actuating signal B is generated.

Another embodiment, a relief safety valve driving system 50 that supplies a driving gas through a driving gas supply line 28 by use of a relief safety valve driving unit for auto-depressurization functions 51 and thereby opens a relief safety valve 5 provided in a main steam system of a nuclear power plant if an accident or a transient state occurs, for protecting a reactor against pressurization, wherein the relief safety valve driving unit for auto-depressurization functions 51 comprises a plurality of solenoid valves for auto-depressurization functions 52 respectively belonging to four safety segments I, II, III and IV, each solenoid valve for auto-depressurization functions 52, being opened by an auto-depressurization system actuating signal A(I), A(II), A(III) and A(IV) belonging to a safety segment corresponding to the solenoid valve for auto-depressurization functions 52; wherein series-connected upstream and downstream solenoid valves for auto-depressurization functions 52 are opened by two or more auto-depressurization system actuating signals A(I), A(II), A(III) and A(IV), among the four auto-depressurization system actuating signals A(I), A(II), A(III) and A(IV) respectively belonging to the four safety segments I, II, III and IV, so as to supply a driving gas to the relief safety valve 5, thereby opening the relief safety valve 5; and wherein the series-connected upstream or downstream solenoid valve for auto-depressurization functions 52 is closed for one or less than one auto-depressurization system actuating signal A(I), A(II), A(III) and A(IV), so as not to supply the driving gas to the relief safety valve 5, thereby closing the relief safety valve 5.

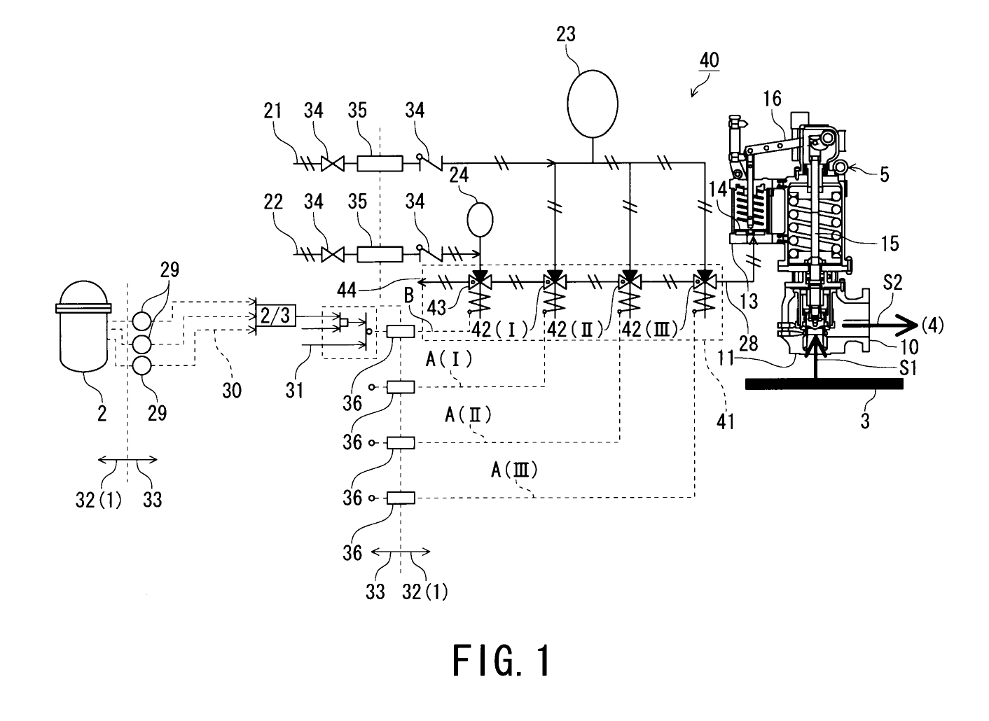

### [A] First Embodiment (FIGS. 1 to 3)

FIG. 1 is a system configuration diagram illustrating a first embodiment of a relief safety valve driving system according to the present invention. In this first embodiment, components the same as those of the above-described related art will be denoted by like reference numerals and characters and will be described in a simplified manner or in no further detail herein.

As illustrated in FIG. 1, a relief safety valve driving system 40 in the present embodiment comprises a relief safety valve 5 mounted on a main steam pipeline 3 of a main steam system in a nuclear power plant. If an accident or a transient state occurs, this relief safety valve 5 is opened by a driving gas supplied from a relief safety valve driving unit 41 through a driving gas supply line 28, thereby protecting a reactor against pressurization.

The relief safety valve driving unit 41 is located between an auto-depressurization system-specific driving gas supply system 21 and the driving gas supply line 28 and between a relief valve functions driving gas supply system 22 and the driving gas supply line 28. As described above, when the driving gas is supplied from this auto-depressurization system-specific driving gas supply system 21 or relief valve functions driving gas supply system 22 to the relief safety valve 5 through the driving gas supply line 28, this relief safety valve 5 opens. In addition, this relief safety valve driving unit 41 comprises three three-way solenoid valves for auto-depressurization functions 42(I), 42(II) and 42(III) respectively belonging to three safety segments I, II and III and one three-way solenoid valve for relief valve functions 43 connected in series with each other. Note that the safety segments I, II and III are shown here by way of example only and may differ from safety segment symbols in actual design.

When the three-way solenoid valve for relief valve functions 43 is not excited, the relief valve functions driving gas supply system 22-side port of the valve is closed and the reactor containment vessel 1-side port and the driving gas supply line 28-side port of the valve are open. When the three-way solenoid valve for relief valve functions 43 is excited, the reactor containment vessel 1-side port is closed and the relief valve functions driving gas supply system 22-side port and the driving gas supply line 28-side port open. This three-way solenoid valve for relief valve functions 43 is excited upon input of a relief valve functions actuating signal B. Consequently, the three-way solenoid valve causes the relief valve functions driving gas supply system 22-side port to open, as described above.

When the three-way solenoid valves for auto-depressurization functions 42(I), 42(II) and 42(III) are not excited, the auto-depressurization system-specific driving gas supply system 21-side ports of the valves are closed and the reactor containment vessel 1-side ports and the driving gas supply line 28-side ports are open. When the three-way solenoid valves for auto-depressurization functions 42(I), 42(II) and 42(III) are excited, the reactor containment vessel 1-side ports of the valves are closed and the auto-depressurization system-specific driving gas supply system 21-side ports and the driving gas supply line 28-side ports are open.

The three-way solenoid valve for auto-depressurization functions 42(I) is excited by an auto-depressurization system actuating signal A(I) belonging to a corresponding safety segment I. Consequently, the three-way solenoid valve causes the relief valve functions driving gas supply system 22-side port thereof to open, as described above. Likewise, the three-way solenoid valve for auto-depressurization functions 42(II) is excited by an auto-depressurization system actuating signal A(II) belonging to a corresponding safety segment II. Consequently, the three-way solenoid valve causes the relief valve functions driving gas supply system 22-side port thereof to open, as described above. Yet likewise, the three-way solenoid valve for auto-depressurization functions 42(III) is excited by an auto-depressurization system actuating signal A(III) belonging to a corresponding safety segment III. Consequently, the three-way solenoid valve causes the relief valve functions driving gas supply system 22-side port thereof to open, as described above.

In this way, the three-way solenoid valves for auto-depressurization functions 42(I), 42(II) and 42(III) belonging to the respective safety segments I, II and III are configured to be physically and electrically independent of one another. Accordingly, even if one safety segment is shut down due to, for example, online maintenance of a power supply system, redundancy is ensured as the result of the remaining two safety segments being in operation. In this case, the functions of the relief safety valve driving unit 41 are not impaired even if a single failure occurs in the remaining two safety segments.

Specifically, any one of the three-way solenoid valves for auto-depressurization functions 42(I), 42(II) and 42(III) is excited by one of the three auto-depressurization system actuating signals A(I), A(II) and A(III) respectively belonging to the three safety segments I, II and III in the relief safety valve driving unit 41, thereby opening the auto-depressurization system-specific driving gas supply system 21-side port of the three-way solenoid valve. Consequently, the driving gas is supplied from the auto-depressurization system-specific driving gas supply system 21 through the driving gas supply line 28, and therefore, the relief safety valve 5 opens. In addition, the relief safety valve driving unit 41 excites the three-way solenoid valve for relief valve functions 43 by a relief valve functions actuating signal B, thereby opening the relief valve functions driving gas supply system 22-side port of the three-way solenoid valve. The driving gas is supplied from the relief valve functions driving gas supply system 22 through the driving gas supply line 28 to open the relief safety valve 5.

In addition, the relief safety valve driving unit 41 maintains the three-way solenoid valves for auto-depressurization functions 42(I), 42(II) and 42(III) and the three-way solenoid valve for relief valve functions 43 in an unexcited state when neither the auto-depressurization system actuating signals A(I), A(II) and A(III) nor the relief valve functions actuating signal B are generated. Consequently, the auto-depressurization system-specific driving gas supply system 21-side ports and relief valve functions driving gas supply system 22-side ports of these three-way solenoid valves are maintained in a closed state. The driving gas is not supplied from either the auto-depressurization system-specific driving gas supply system 21 or the relief valve functions driving gas supply system 22. Thus, the relief safety valve 5 is maintained in a closed state.

The relief safety valve driving unit 41 is provided with a malfunction preventing pipeline 44 one end of which is open into a reactor containment vessel 1. This malfunction preventing pipeline 44 is configured so that when all of the three-way solenoid valves for auto-depressurization functions 42(I), 42(II) and 42(III) and the three-way solenoid valve for relief valve functions 43 are in an unexcited state, the auto-depressurization system-specific driving gas supply system 21-side ports and relief valve functions driving gas supply system 22-side ports of these three-way solenoid valves are closed. At this time, a driving gas leaking from these three-way solenoid valves is released into the reactor containment vessel 1, and therefore, does not internally pressurize the driving gas supply line 28. Thus, the driving gas does not cause the relief safety valve 5 to operate erroneously (open).

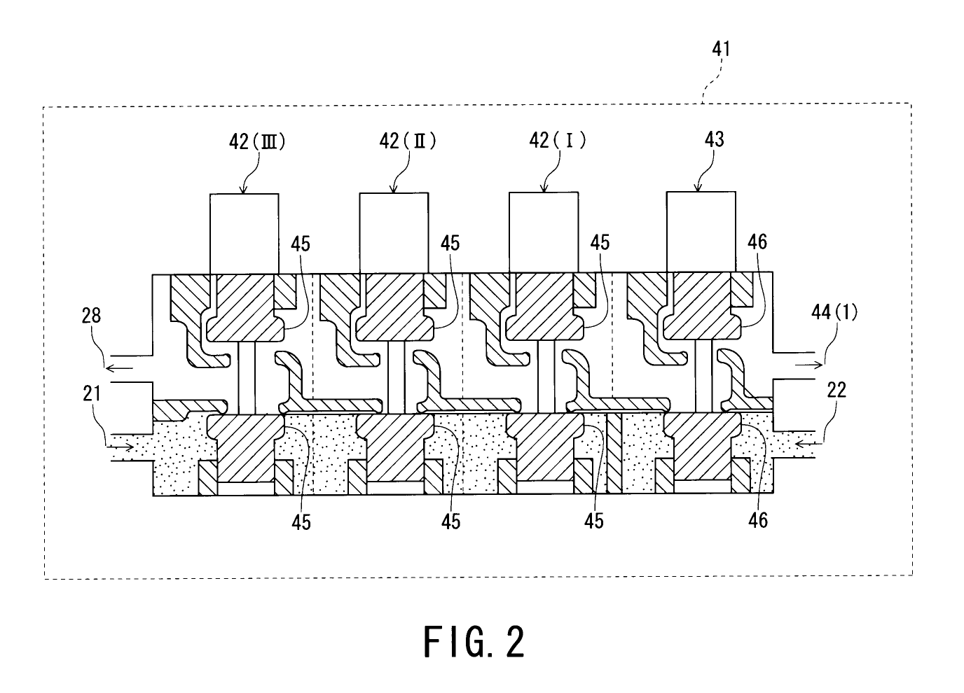

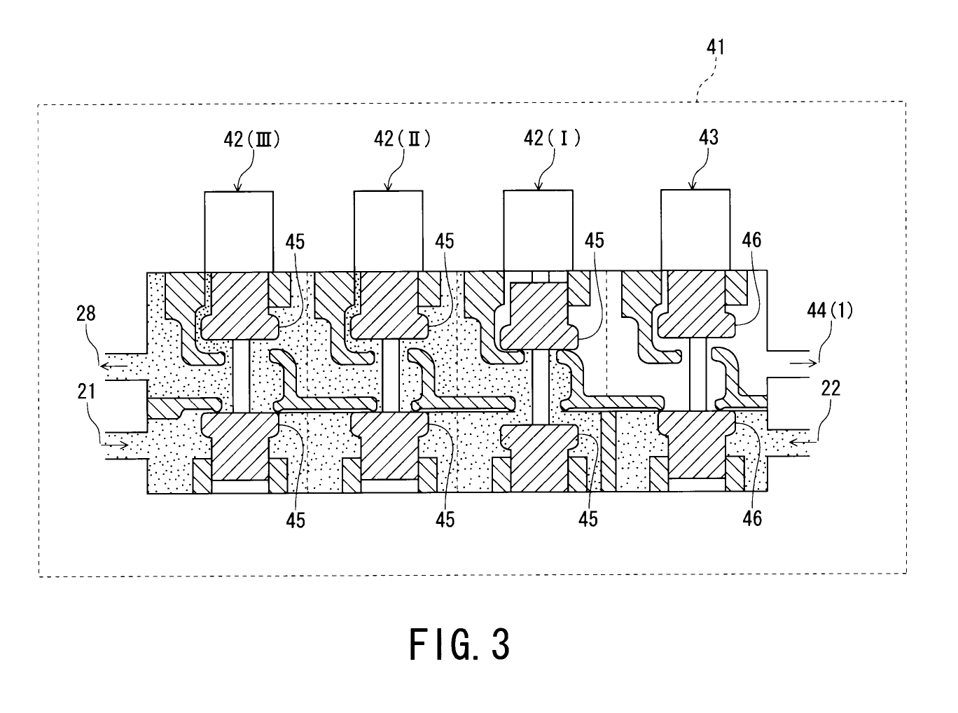

Here, the relief safety valve driving unit 41 of the present embodiment is configured integrally with the built-in three-way solenoid valves for auto-depressurization functions 42(I), 42(II) and 42(III) and the three-way solenoid valve for relief valve functions 43, as illustrated in FIGS. 2 and 3.

That is, the three-way solenoid valves for auto-depressurization functions 42(I), 42(II) and 42(III) and the three-way solenoid valve for relief valve functions 43 are normally in an unexcited state, as illustrated in FIG. 2. At this time, the respective valve elements 45 of the three-way solenoid valves for auto-depressurization functions 42(I), 42(II) and 42(III) and the valve element 46 of the three-way solenoid valve for relief valve functions 43 place the auto-depressurization system-specific driving gas supply system 21-side ports and the relief valve functions driving gas supply system 22-side ports in a closed state. Accordingly, the driving gas is not supplied from either the auto-depressurization system-specific driving gas supply system 21 or the relief valve functions driving gas supply system 22 to the driving gas supply line 28. Thus, the relief safety valve 5 is placed in a closed state. Dotted portions of FIGS. 2 and 3 show areas filled with the driving gas.

Even if any one of the valve elements 45 of the three-way solenoid valve for auto-depressurization functions 42(I), 42(II) and 42(III) or the valve element 46 of the three-way solenoid valve for relief valve functions 43 suffers leakage, the driving gas flows out from the malfunction preventing pipeline 44 into the reactor containment vessel 1. Consequently, the driving gas supply line 28 is not pressurized and thereby the relief safety valve 5 is prevented from operating erroneously (opening).

On the other hand, if any one of the three-way solenoid valve for auto-depressurization functions 42(I), 42(II) and 42(III) and the three-way solenoid valve for relief valve functions 43 is excited, the valve element 45 of the excited three-way solenoid valve for auto-depressurization functions 42(I), 42(II) or 42(III) or the valve element 46 of the excited three-way solenoid valve for relief valve functions 43 moves, as illustrated in FIG. 3. Then, the auto-depressurization system-specific driving gas supply system 21-side port or the relief valve functions driving gas supply system 22-side port of the excited three-way solenoid valve opens. At this time, the malfunction preventing pipeline 44 is shut off. Consequently, the driving gas is supplied from the auto-depressurization system-specific driving gas supply system 21 or the relief valve functions driving gas supply system 22 to the driving gas supply line 28, thereby causing the relief safety valve 5 to open.

FIG. 3 illustrates a state in which the three-way solenoid valve for auto-depressurization functions 42(I) is excited. In this case, the valve element 45 of this three-way solenoid valve for auto-depressurization functions 42(I) moves. Thus, the driving gas is supplied to the driving gas supply line 28, thereby causing the relief safety valve 5 to open. Note that operation of the three-way solenoid valves for auto-depressurization functions 42(I), 42(II) and 42(III) and operation of the three-way solenoid valve for relief valve functions 43 do not interfere with each other.

According to the present embodiment configured as described above, the following advantageous effect (1) is produced:

(1) The relief safety valve driving unit 41 in the relief safety valve driving system 40 enables the relief safety valve 5 to open by one or more auto-depressurization system actuating signals, among the three auto-depressurization system actuating signals A(I), A(II) and A(III) respectively belonging to the three safety segments I, II and III, or by the relief valve functions actuating signal B. Consequently, redundancy is ensured even at the time of online maintenance for each of the safety segments I, II and III. Thus, it is possible to satisfy single-failure criteria, thereby improving the reliability of the relief safety valve driving system 40. In this way, the relief safety valve driving system 40 can be made compatible with, for example, online maintenance of a power supply system for each of the safety segments I, II and III. Consequently, it is possible to shorten a reactor shutdown period in the periodic inspection of a nuclear power plant and improve the availability factor thereof.

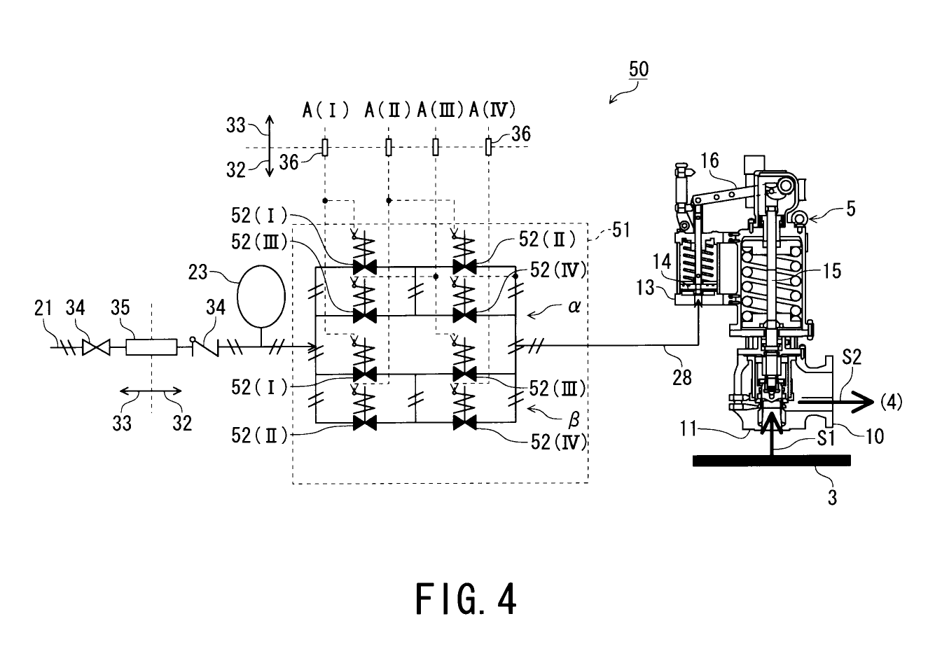

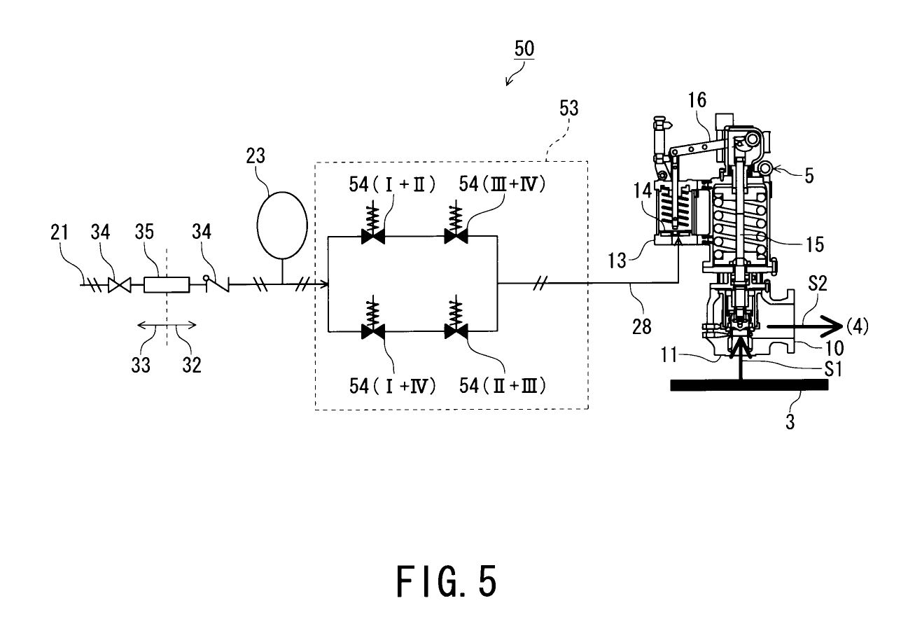

### [B] Second Embodiment (FIGS. 4 and 5)

FIG. 4 is a system configuration diagram illustrating a second embodiment of the relief safety valve driving system according to the present invention. In this second embodiment, components the same as those of the above-described related art and the first embodiment will be denoted by like reference numerals and characters and will be described in a simplified manner or in no further detail.

A relief safety valve driving system 50 of the present embodiment comprises a relief safety valve 5 mounted on a main steam pipeline 3 of a main steam system in a nuclear power plant. If an accident or a transient state occurs, this relief safety valve 5 is opened by a driving gas supplied from a relief safety valve driving unit for auto-depressurization functions 51 through a driving gas supply line 28, thereby protecting a reactor against pressurization.

The relief safety valve driving unit for auto-depressurization functions 51 is located between an auto-depressurization system-specific driving gas supply system 21 and the driving gas supply line 28. The driving gas from the auto-depressurization system-specific driving gas supply system 21 is supplied through the driving gas supply line 28, as described above, to cause the relief safety valve 5 to open. This relief safety valve driving unit for auto-depressurization functions 51 comprises a circuit provided with a total of eight solenoid valves for auto-depressurization functions respectively belonging, in units of two, to four safety segments I, II, III and IV, i.e., solenoid valves 52(I), 52(II), 52(III) and 52(IV).

The solenoid valve 52(I) is opened by an auto-depressurization system actuating signal A(I) belonging to a corresponding safety segment I and is closed in the absence of this auto-depressurization system actuating signal A(I). Likewise, the solenoid valve 52(II) is opened by an auto-depressurization system actuating signal A(II) belonging to a corresponding safety segment II and is closed in the absence of this auto-depressurization system actuating signal A(II). Yet likewise, the solenoid valve 52(III) is opened by an auto-depressurization system actuating signal A(III) belonging to a corresponding safety segment III and is closed in the absence of this auto-depressurization system actuating signal A(III). Still likewise, the solenoid valve 52(IV) is opened by an auto-depressurization system actuating signal A(IV) belonging to a corresponding safety segment IV and is closed in the absence of this auto-depressurization system actuating signal A(IV).

In this way, the solenoid valves 52(I), 52(II), 52(III) and 52(IV) belonging to the respective safety segments I, II, III and IV are configured to be physically and electrically independent of one another. Accordingly, even if one safety segment is shut down due to, for example, online maintenance of a power supply system, redundancy is ensured since the remaining three safety segments are in operation. In this case, the functions of the relief safety valve driving unit for auto-depressurization functions 51 are not impaired even if a single failure occurs in one of the remaining three safety segments.

Specifically, the relief safety valve driving unit for auto-depressurization functions 51 operates the solenoid valves 52(I), 52(II), 52(III) and 52(IV) according to a 2-out-of-4 logic. That is, the relief safety valve driving unit for auto-depressurization functions 51 opens the series-connected upstream and downstream solenoid valves 52(I) to 52(IV) by two or more auto-depressurization system actuating signals, among the four auto-depressurization system actuating signals A(I), A(II), A(III) and A(IV) respectively belonging to the four safety segments I, II, III and IV. The driving gas is supplied from the auto-depressurization system-specific driving gas supply system 21 through the driving gas supply line 28, thus causing the relief safety valve 5 to open. The series-connected upstream or downstream solenoid valves 52(I) to 52(IV) are closed by one or less than one auto-depressurization system actuating signal. Consequently, the driving gas is not supplied from the auto-depressurization system-specific driving gas supply system 21. Thus, the relief safety valve 5 is maintained in a closed state.

In the present embodiment, the solenoid valves 52(I), 52(II), 52(III) and 52(IV) are provided, one each, in a region α and a region β. In the region α, the upstream solenoid valves 52(I) and 52(III) are parallel-connected, and the solenoid valves 52(II) and 52(IV) are series-connected downstream of these respective solenoid valves. Likewise, in the region β, the upstream solenoid valves 52(I) and 52(II) are parallel-connected, and the solenoid valves 52(III) and 52(IV) are series-connected downstream of these respective solenoid valves.

For example, if the auto-depressurization system actuating signals A(I) and A(III) are input to the relief safety valve driving unit for auto-depressurization functions 51, the solenoid valves 52(I) and 52(III) series-connected in the region β are opened. Then, the driving gas is supplied from the auto-depressurization system-specific driving gas supply system 21 through the relief safety valve driving unit for auto-depressurization functions 51 and the driving gas supply line 28, thereby opening the relief safety valve 5.

FIG. 5 is a system configuration diagram illustrating a modified embodiment of the relief safety valve driving system 50 of FIG. 4. A relief safety valve driving unit for auto-depressurization functions 53 of this modified embodiment functions in the same way as the relief safety valve driving unit for auto-depressurization functions 51 of FIG. 4, except that the relief safety valve driving unit for auto-depressurization functions 53 comprises four solenoid valves for auto-depressurization functions, i.e., solenoid valves 54(I+II), 54(III+IV), 54(I+IV) and 54(II+III). For example, the relief safety valve driving unit for auto-depressurization functions 53 comprises the downstream solenoid valve 54(III+IV) series-connected to the solenoid valve 54(I+II) of the parallel-connected upstream solenoid valves 54(I+II) and 54(I+IV), and the downstream solenoid valve 54(II+III) series-connected to the solenoid valve 54(I+IV).

These solenoid valves 54(I+II), 54(III+IV), 54(I+IV) and 54(II+III) are respectively provided with solenoids fed with power from two safety segments. These solenoid valves are excited and opened if any one of the auto-depressurization system actuating signals A(I) to A(IV) belonging to the safety segments I to IV is input. For example, the solenoid valve 54(I+II) is provided with a solenoid fed with power from the safety segments I and II, and is excited and opened by the auto-depressurization system actuating signal A(I) or A(II).

According to the present embodiment configured as described above, the following advantageous effects (2) and (3) are produced:

(2) The relief safety valve driving units for auto-depressurization functions 51 and 53 of the relief safety valve driving system 50 are configured so that the series-connected upstream and downstream solenoid valves (for example, the solenoid valves 52(I) and 52(III)) are opened by two or more auto-depressurization system actuating signals, among the four auto-depressurization system actuating signals A(I), A(II), A(III) and A(IV) respectively belonging to the four safety segments II, III and IV, thereby enabling the relief safety valve 5 to open. Consequently, redundancy is ensured even at the time of online maintenance for each of the safety segments I, II, III and IV. Thus, it is possible to satisfy single-failure criteria, thereby improving the reliability of the relief safety valve driving system 50. In this way, the relief safety valve driving system 50 can be made compatible with, for example, online maintenance of a power supply system for each of the safety segments I, II, III and IV. Consequently, it is possible to shorten a period of reactor shutdown in the periodic inspection of a nuclear power plant and improve the availability factor thereof.

(3) For one or less than one auto-depressurization system actuating signal, among the four auto-depressurization system actuating signals A(I), A(II), A(III) and A(IV) respectively belonging to the four safety segments I, II, III and IV, the series-connected upstream or downstream solenoid valves are closed. Thus, the relief safety valve 5 is maintained in a closed state. Consequently, even if any one of the auto-depressurization system actuating signals A(I), A(II), A(III) and A(IV) is erroneously generated, the relief safety valve 5 does not open. Thus, it is possible to prevent the relief safety valve 5 from false operation.

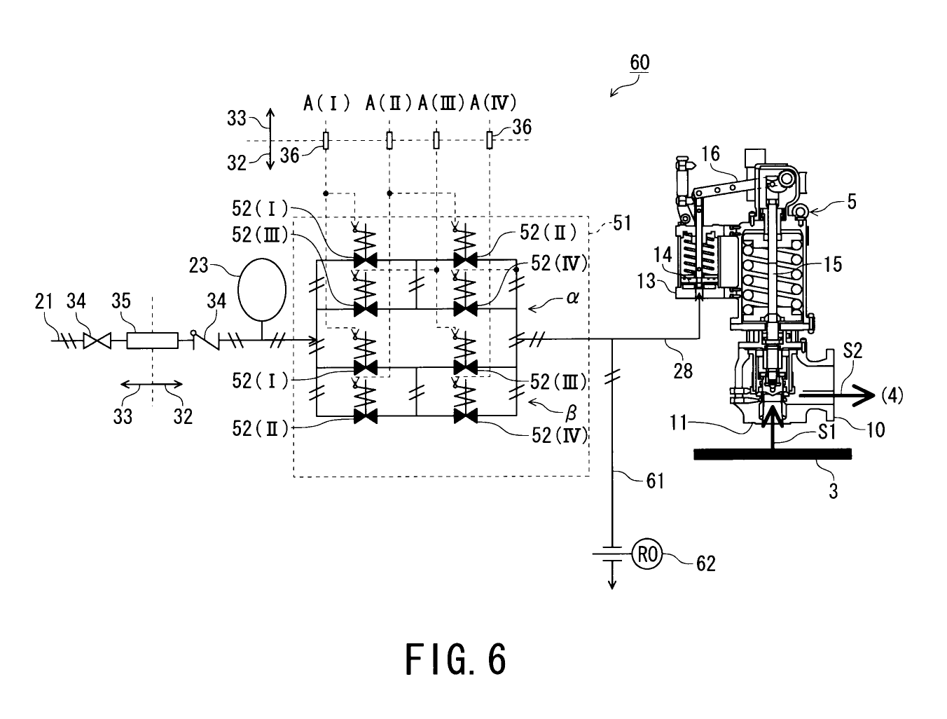

### [C] Third Embodiment (FIG. 6)

FIG. 6 is a system configuration diagram illustrating a third embodiment of the relief safety valve driving system according to the present invention. In this third embodiment, components the same as those of the above-described related art and the first and second embodiments will be denoted by like reference numerals and characters and will be described in a simplified manner or in no further detail.

The difference of a relief safety valve driving system 60 of the present embodiment from the relief safety valve driving system 50 of the above-described second embodiment is as follows: A malfunction preventing pipeline 61 open into a reactor containment vessel 1 is connected downstream of the driving gas supply line 28 of a relief safety valve driving unit for auto-depressurization functions 51. When solenoid valves 52(I), 52(II), 52(III) and 52(IV) constituting the relief safety valve driving unit for auto-depressurization functions 51 are closed, this malfunction preventing pipeline 61 releases a driving gas leaking from these solenoid valves into a reactor containment vessel 1. Consequently, the driving gas supply line 28 is prevented from being pressurized by the leaked driving gas, thereby preventing the relief safety valve 5 from false operation (opening operation).

That is, though the solenoid valves 52(I), 52(II), 52(III) and 52(IV) of the relief safety valve driving unit for auto-depressurization functions 51 are normally closed, a small leakage of the driving gas from a marginal gap may occur. In order to prevent the driving gas supply line 28 from being pressurized by this leakage and prevent the relief safety valve 5 from false operation (opening operation), the normally-open malfunction preventing pipeline 61 is connected to part of the driving gas supply line 28 downstream of the relief safety valve driving unit for auto-depressurization functions 51 and upstream of the relief safety valve 5. An orifice 62 is disposed, as necessary, in this malfunction preventing pipeline 61, in order to prevent the driving gas from leaking from the malfunction preventing pipeline 61 while the relief safety valve 5 is in operation.

According to the present embodiment, the following advantageous effect (4) is produced, in addition to advantageous effects similar to the advantageous effects (2) and (3) of the above-described second embodiment:

(4) The malfunction preventing pipeline 61 open into the reactor containment vessel 1 is disposed in part of the driving gas supply line 28 downstream of the relief safety valve driving unit for auto-depressurization functions 51. Consequently, even if the driving gas leaks from the solenoid valves 52(I), 52(II), 52(III) and 52(IV) constituting the relief safety valve driving unit for auto-depressurization functions 51, the relief safety valve 5 is prevented from false operation (opening operation).

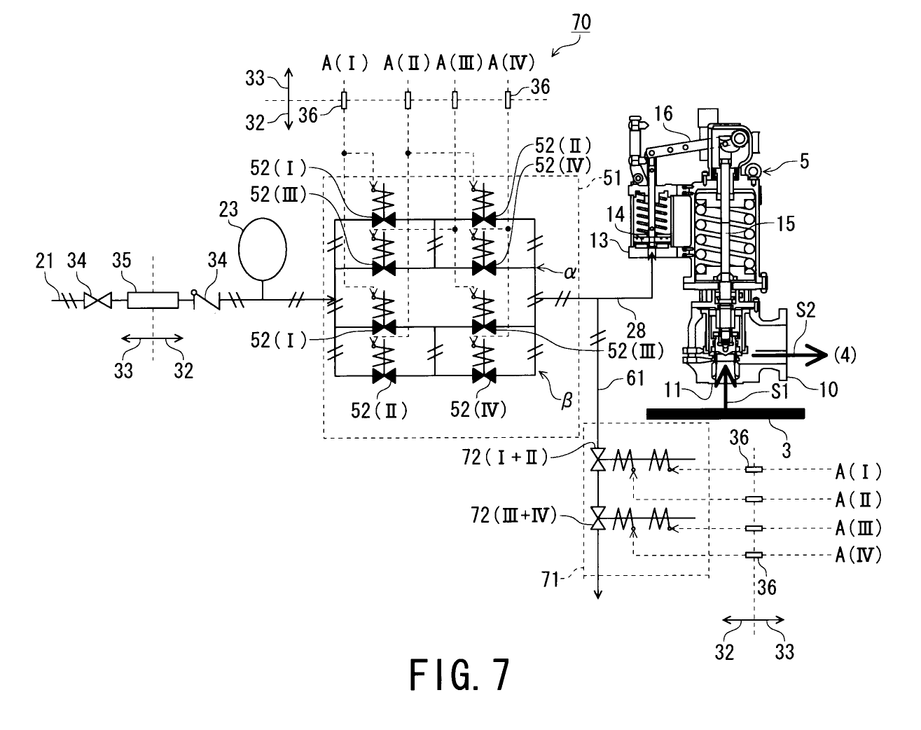

### [D] Fourth Embodiment (FIG. 7)

FIG. 7 is a system configuration diagram illustrating a fourth embodiment of the relief safety valve driving system according to the present invention. In this fourth embodiment, components the same as those of the above-described related art and the first to third embodiments will be denoted by like reference numerals and characters and will be described in a simplified manner or in no further detail.

The difference of a relief safety valve driving system 70 of the present embodiment from the relief safety valve driving system 60 of the above-described third embodiment is as follows: Instead of the orifice 62, an opening operation ensuring unit for auto-depressurization functions 71 provided with series-connected solenoid valves 72(I+II) and 72(III+IV) is disposed on the malfunction preventing pipeline 61.

This opening operation ensuring unit for auto-depressurization functions 71 shuts off the malfunction preventing pipeline 61 according to a 1-out-of-4 logic. That is, the solenoid valve 72(I+II) of the opening operation ensuring unit for auto-depressurization functions 71 is closed by either one of the auto-depressurization system actuating signals A(I) and A(II), among the four auto-depressurization system actuating signals A(I), A(II), A(III) and A(IV), thereby shutting off the malfunction preventing pipeline 61. Likewise, the solenoid valve 72(III+IV) is closed by either one of the auto-depressurization system actuating signals A(III) and A(IV), thereby shutting off the malfunction preventing pipeline 61.

The relief safety valve driving unit for auto-depressurization functions 51 supplies the driving gas from the auto-depressurization system-specific driving gas supply system 21 through the driving gas supply line 28 to the relief safety valve 5, in response to two or more auto-depressurization system actuating signals, among the auto-depressurization system actuating signals A(I), A(II), A(III) and A(IV). At this time, either the solenoid valve 72(I+II) or 72(III+IV) of the opening operation ensuring unit for auto-depressurization functions 71 is closed to shut off the malfunction preventing pipeline 61. Consequently, the driving gas flowing through the driving gas supply line 28 is prevented from flowing out into the reactor containment vessel 1 through the malfunction preventing pipeline 61. Accordingly, opening operation of the relief safety valve 5 is ensured without having to increase the capacity of the accumulator 23 of the auto-depressurization system-specific driving gas supply system 21.

According to the present embodiment configured as described above, the following advantageous effect (5) is produced, in addition to advantageous effects similar to the advantageous effects (2) to (4) of the above-described second and third embodiments:

(5) The opening operation ensuring unit for auto-depressurization functions 71 which shuts off the malfunction preventing pipeline 61 by any one of the four auto-depressurization system actuating signals A(I), A(II), A(III) and A(IV) is disposed on the malfunction preventing pipeline 61 connected to the driving gas supply line 28. Consequently, when the driving gas of the auto-depressurization system-specific driving gas supply system 21 is supplied to the relief safety valve 5 through the relief safety valve driving unit for auto-depressurization functions 51 and the driving gas supply line 28 by the operation of the relief safety valve driving unit for auto-depressurization functions 51, the driving gas is prevented from flowing out from the driving gas supply line 28 through the malfunction preventing pipeline 61. As a result, opening operation of the relief safety valve 5 is ensured.

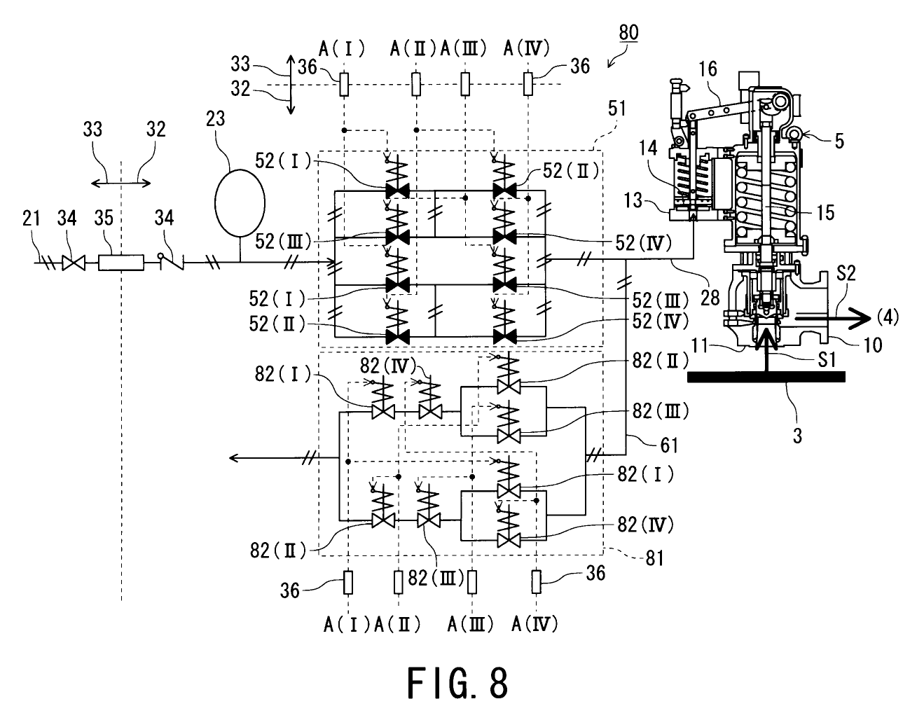

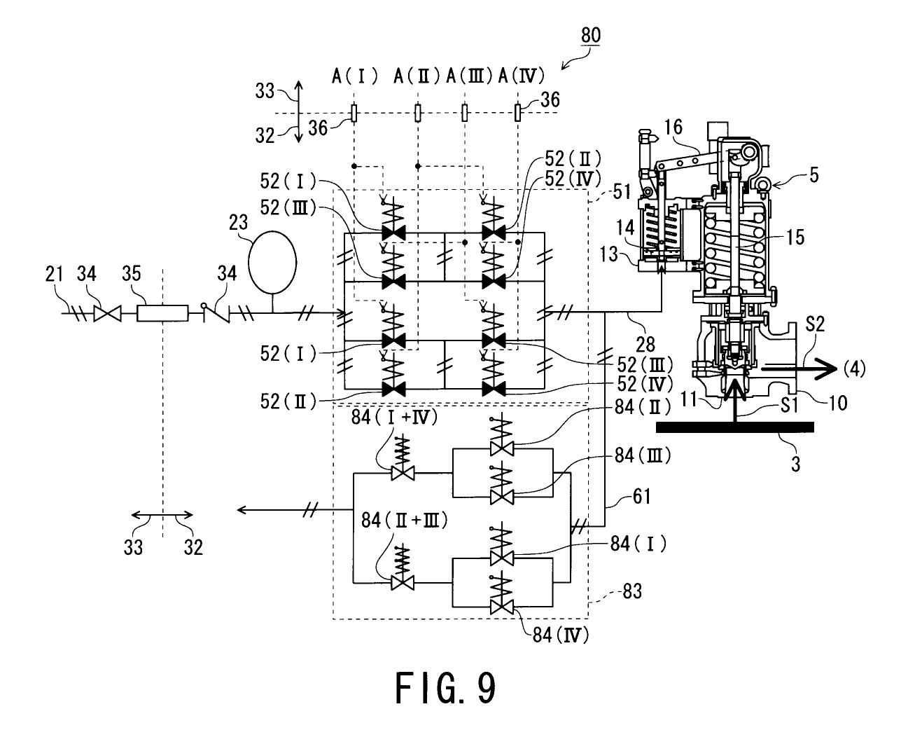

### [E] Fifth Embodiment (FIGS. 8 and 9)

FIG. 8 is a system configuration diagram illustrating a fifth embodiment of the relief safety valve driving system according to the present invention, whereas FIG. 9 is a system configuration diagram illustrating a modified embodiment of the relief safety valve driving system of FIG. 8. In this fifth embodiment, components the same as those of the above-described related art and the first to third embodiments will be denoted by like reference numerals and characters and will be described in a simplified manner or in no further detail.

The difference of a relief safety valve driving system 80 of the present embodiment from the relief safety valve driving system 60 of the above-described third embodiment is as follows: Instead of the orifice 62, an opening operation ensuring unit for auto-depressurization functions 81 provided with two each of solenoid valves 82(I), 82(II), 82(III) and 82(IV) (FIG. 8), thus eight in total, or an opening operation ensuring unit for auto-depressurization functions 83 provided with six solenoid valves 84(I), 84(II), 84(III), 84(IV), 84(I+IV) and 84(II+III) (FIG. 9) is disposed on the malfunction preventing pipeline 61.

These opening operation ensuring units for auto-depressurization functions 81 and 83 operate according to a 2-out-of-4 logic. That is, the opening operation ensuring units for auto-depressurization functions 81 and 83 maintain the malfunction preventing pipeline 61 open into the reactor containment vessel 1 for one or less than one auto-depressurization system actuating signal, among the four auto-depressurization system actuating signals A(I), A(II), A(III) and A(IV). For two or more auto-depressurization system actuating signals, the opening operation ensuring units for auto-depressurization functions 81 and 83 shut off the malfunction preventing pipeline 61.

In the opening operation ensuring unit for auto-depressurization functions 81 illustrated in FIG. 8, the solenoid valves 82(I) and 82(II) are connected in parallel with each other. The solenoid valve 82(IV) is series-connected to this solenoid valve 82(I). In addition, the parallel-connected solenoid valves 82(II) and 82(III) are series-connected to this solenoid valve 82(I). Likewise, the solenoid valve 82(III) is series-connected to the solenoid valve 82(II). In addition, the parallel-connected solenoid valves 82(I) and 82(IV) are series-connected to the solenoid valve 82(II).

Here, the solenoid valve 82(I) is closed by the auto-depressurization system actuating signal A(I) and is opened in the absence of this auto-depressurization system actuating signal A(I). Likewise, the solenoid valve 82(II) is closed by the auto-depressurization system actuating signal A(II) and is opened in the absence of this auto-depressurization system actuating signal A(II). Yet likewise, the solenoid valve 82(III) is closed by the auto-depressurization system actuating signal A(III) and is opened in the absence of this auto-depressurization system actuating signal A(III). Still likewise, the solenoid valve 82(IV) is closed by the auto-depressurization system actuating signal A(IV) and is opened in the absence of this auto-depressurization system actuating signal A(IV).

This opening operation ensuring unit for auto-depressurization functions 81 maintains the malfunction preventing pipeline 61 in an open state when, for example, only the solenoid valve 82(I) is closed by the auto-depressurization system actuating signal A(I). In addition, the opening operation ensuring unit for auto-depressurization functions 81 closes the solenoid valves 82(I) and 82(III) by, for example, the auto-depressurization system actuating signals A(I) and A(III) to shut off the malfunction preventing pipeline 61. If two or more auto-depressurization system actuating signals are generated, the relief safety valve driving unit for auto-depressurization functions 51 supplies the driving gas of the auto-depressurization system-specific driving gas supply system 21 through the driving gas supply line 28 to the relief safety valve 5. Consequently, the malfunction preventing pipeline 61 is shut off, thereby ensuring the opening operation of the relief safety valve 5 by the driving gas.

The opening operation ensuring unit for auto-depressurization functions 83 illustrated in FIG. 9 comprises solenoid valves 84(I+IV) and 84(II+III) connected in parallel with each other. The parallel-connected solenoid valves 84(II) and 84(III) are series-connected to this solenoid valve 84(I+IV). Likewise, the parallel-connected solenoid valves 84(I) and 84(IV) are series-connected to the solenoid valve 84(II+III).

Here, the solenoid valves 84(I), 84(II), 84(III) and 84(IV) are respectively closed by the auto-depressurization system actuating signals A(I), A(II), A(III) and A(IV) and are opened in the absence of the auto-depressurization system actuating signals A(I), A(II), A(III) and A(IV). Likewise, the solenoid valve 84(I+IV) is closed by the auto-depressurization system actuating signal A(I) or A(IV) and is opened in the absence of the auto-depressurization system actuating signals A(I) and A(IV). Yet likewise, the solenoid valve 84(II+III) is closed by the auto-depressurization system actuating signal A(II) or A(III) and is opened in the absence of these auto-depressurization system actuating signals A(II) and A(III).

Also in this opening operation ensuring unit for auto-depressurization functions 83, the malfunction preventing pipeline 61 is maintained in an open state when the solenoid valves 84(I) and 84(I+IV) are closed by, for example, the auto-depressurization system actuating signal A(I). In addition, the solenoid valves 84(I), 84(III), 84(I+IV) and 84(II+III) are closed by the auto-depressurization system actuating signals A(I) and A(III), and therefore, the malfunction preventing pipeline 61 is placed in a closed state. Consequently, the driving gas from the auto-depressurization system-specific driving gas supply system 21 is supplied to the relief safety valve 5 without flowing out from the malfunction preventing pipeline 61. Thus, opening operation of this relief safety valve 5 is ensured.

According to the present embodiment configured as described above, the following advantageous effects (6) to (8) are produced, in addition to advantageous effects similar to the advantageous effects (2) to (4) of the above-described second and third embodiments:

(6) The opening operation ensuring unit for auto-depressurization functions 81 or 83 for maintaining the malfunction preventing pipeline 61 in a open state by one or less than one auto-depressurization system actuating signal, among the four auto-depressurization system actuating signals A(I), A(II), A(III) and A(IV) and closing the malfunction preventing pipeline 61 by two or more auto-depressurization system actuating signals is disposed on the malfunction preventing pipeline 61 to be connected to the driving gas supply line 28. Consequently, the driving gas of the auto-depressurization system-specific driving gas supply system 21, when supplied to the relief safety valve 5 through the relief safety valve driving unit for auto-depressurization functions 51 and the driving gas supply line 28 by the operation of the relief safety valve driving unit for auto-depressurization functions 51, can be prevented from flowing out from the driving gas supply line 28 through the malfunction preventing pipeline 61. As a result, opening operation of the relief safety valve 5 can be ensured.

(7) The opening operation ensuring unit for auto-depressurization functions 81 or 83 maintains the malfunction preventing pipeline 61 in an open state for one or less than one auto-depressurization system actuating signal, among the auto-depressurization system actuating signals A(I), A(II), A(III) and A(IV). The opening operation ensuring unit for auto-depressurization functions 81 or 83 therefore does not shut off the malfunction preventing pipeline 61 even if any one of the auto-depressurization system actuating signal A(I) to A(IV) is erroneously generated. Consequently, the opening operation ensuring unit for auto-depressurization functions 81 or 83, in conjunction with the functions of the relief safety valve driving unit for auto-depressurization functions 51, prevents the relief safety valve 5 from false operation (opening operation) even if any one of the auto-depressurization system actuating signals A(I) to A(IV) is erroneously generated.

(8) The opening operation ensuring unit for auto-depressurization functions 81 or 83 shuts off the malfunction preventing pipeline 61 by two or more auto-depressurization system actuating signals, among the auto-depressurization system actuating signals A(I), A(II), A(III) and A(IV). Consequently, redundancy is ensured even at the time of online maintenance for each of the safety segments I, II, III and IV, thereby satisfying single-failure criteria. Accordingly, it is possible to improve the reliability of the opening operation ensuring unit for auto-depressurization functions 81 or 83, and thus the reliability of the relief safety valve driving system 80.

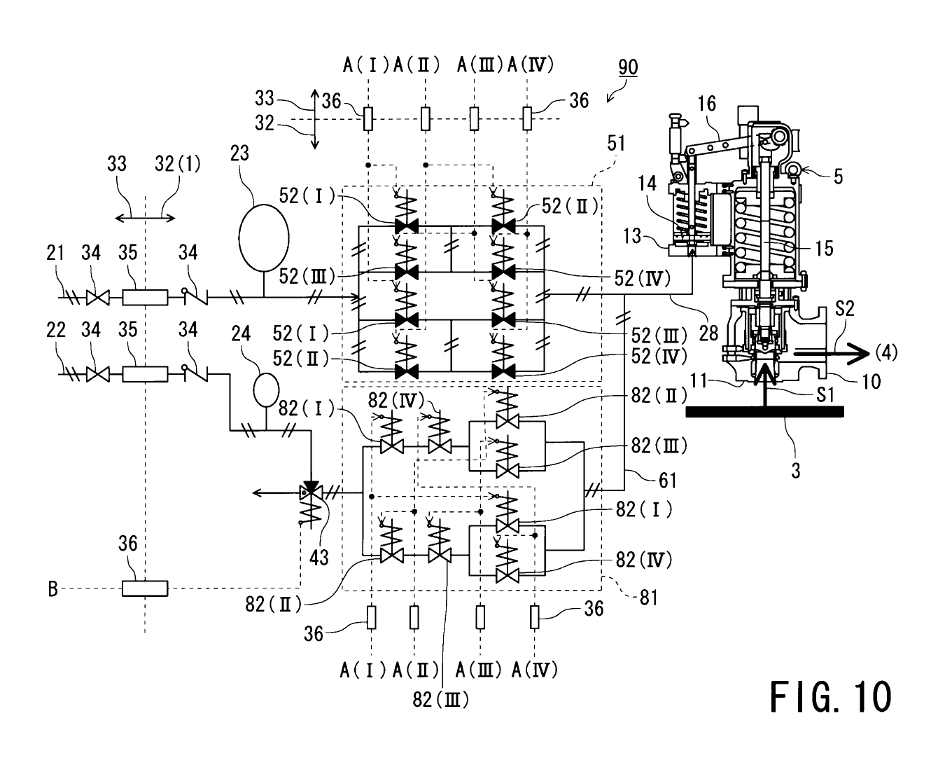

### [F] Sixth Embodiment (FIGS. 10 to 12)

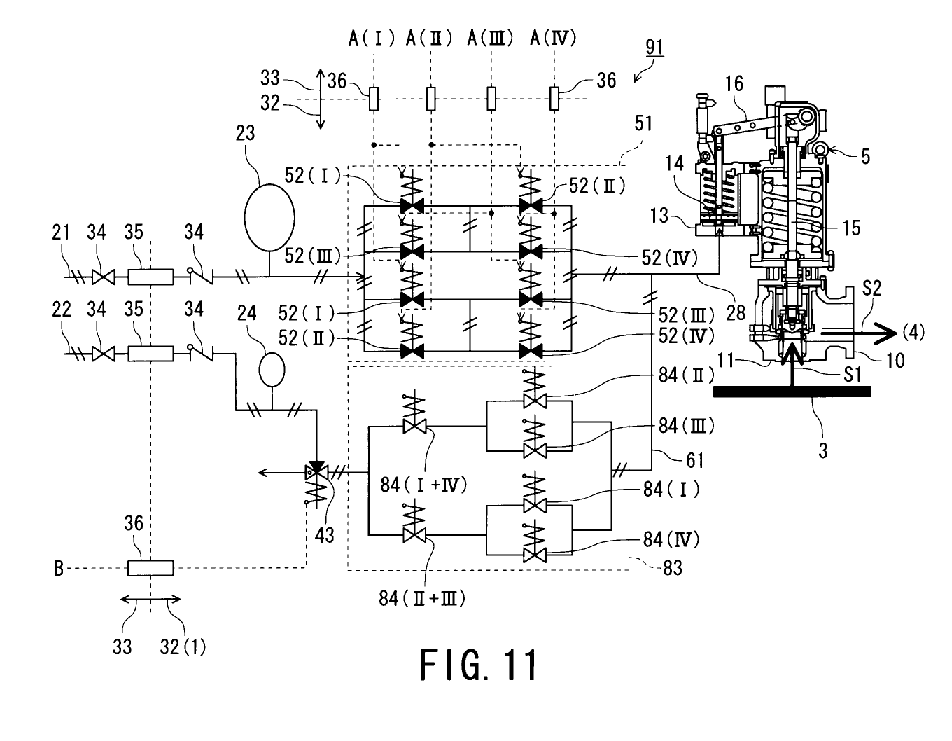

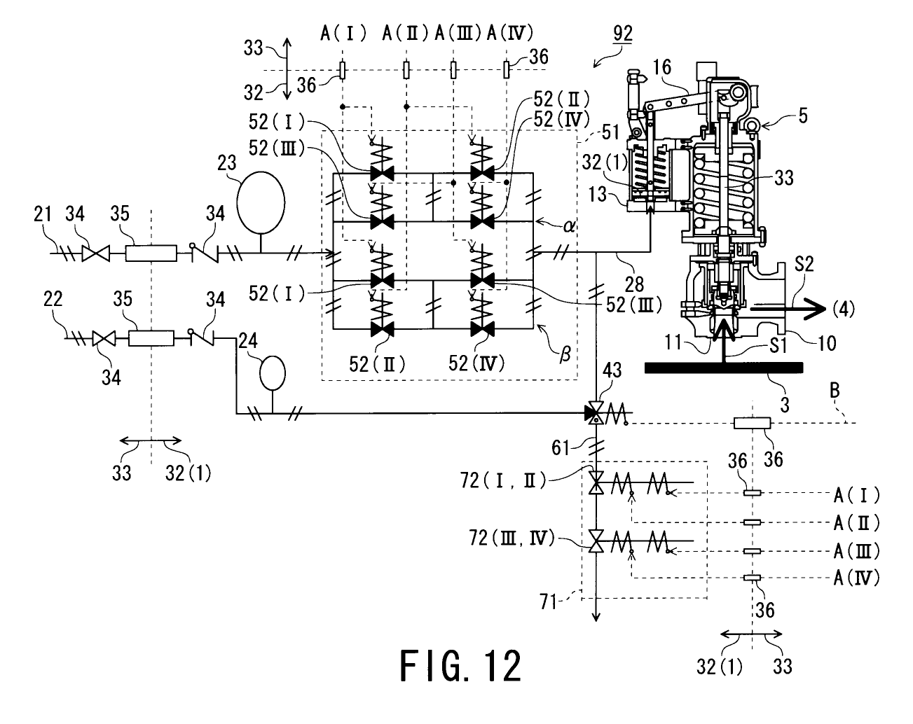

FIG. 10 is a system configuration diagram illustrating a sixth embodiment of the relief safety valve driving system according to the present invention, whereas FIG. 11 is a system configuration diagram illustrating a modified embodiment of the relief safety valve driving system of FIG. 10. In addition, FIG. 12 is a system configuration diagram illustrating another modified embodiment of the relief safety valve driving system of FIG. 10. In this sixth embodiment, components the same as those of the related art and the first to fifth embodiments will be denoted by like reference numerals and characters and will be described in a simplified manner or in no further detail.

The difference of a relief safety valve driving systems 90 (FIG. 10), 91 (FIGS. 11) and 92 (FIG. 12) of the present embodiment from those of the above-described fourth and fifth embodiments is as follows: Opening operation ensuring units for auto-depressurization functions 81 (FIG. 10), 83 (FIGS. 11) and 71 (FIG. 12) are respectively disposed on the malfunction preventing pipeline 61. A relief valve functions driving gas supply system 22 for supplying a driving gas to open the relief safety valve 5 is connected to this malfunction preventing pipeline 61 through a three-way solenoid valve for relief valve functions 43.

In the relief safety valve driving systems 90 and 91 illustrated in FIGS. 10 and 11, the three-way solenoid valve for relief valve functions 43 is connected to part of the malfunction preventing pipeline 61 downstream of the opening operation ensuring unit for auto-depressurization functions 81 and 83, respectively. In the relief safety valve driving system 92 illustrated in FIG. 12, the three-way solenoid valve for relief valve functions 43 is connected to part of the malfunction preventing pipeline 61 upstream of the opening operation ensuring unit for auto-depressurization functions 71. In this regard, however, the three-way solenoid valve for relief valve functions 43 may be connected to part of the malfunction preventing pipeline 61 upstream of the opening operation ensuring units for auto-depressurization functions 81 and 83, respectively, also in the relief safety valve driving systems 90 and 91, as in the relief safety valve driving system 92.

In these relief safety valve driving systems 90, 91 and 92, the relief valve functions driving gas supply system 22-side port of the three-way solenoid valve for relief valve functions 43 is closed in an unexcited state in which the relief valve functions actuating signal B is not generated and the driving gas supply line 28-side port and the reactor containment vessel 1-side port thereof are open. Consequently, at this time, the relief safety valve 5 is open into the reactor containment vessel 1 through the driving gas supply line 28, the malfunction preventing pipeline 61, and the opening operation ensuring unit for auto-depressurization functions 81 (83 or 71).

The reactor containment vessel 1-side port of the three-way solenoid valve for relief valve functions 43 is closed when the relief valve functions actuating signal B is generated and therefore the valve is excited, and the relief valve functions driving gas supply system 22-side port and the driving gas supply line 28-side port of the valve are opened. Since the auto-depressurization system actuating signals A(I), A(II), A(III) and A(IV) are not generated at this time, the opening operation ensuring units for auto-depressurization functions 81, 83 and 71 place the malfunction preventing pipeline 61 in an open state. Consequently, when this three-way solenoid valve for relief valve functions 43 is excited, the driving gas within the relief valve functions driving gas supply system 22 is supplied through the three-way solenoid valve for relief valve functions 43, the opening operation ensuring unit for auto-depressurization functions 81 (83 or 71), the malfunction preventing pipeline 61, and the driving gas supply line 28, thereby opening the relief safety valve 5.

According to the present embodiment configured as described above, the following advantageous effect (9) is produced, in addition to advantageous effects similar to the advantageous effects (2) to (8) of the above-described second to fifth embodiments:

(9) The relief valve functions driving gas supply system 22 is connected through the three-way solenoid valve for relief valve functions 43 to the malfunction preventing pipeline 61 on which the opening operation ensuring unit for auto-depressurization functions 81, 83 or 71 is disposed. With this relief valve functions driving gas supply system 22, a system for opening the relief safety valve 5 is configured by taking advantage of the malfunction preventing pipeline 61. As a result, it is possible to simplify the system configuration of the relief safety valve driving systems 90, 91 and 92 and reduce the costs thereof.

While certain embodiments have been described, these embodiments have been presented by way of example only, and are not intended to limit the scope of the inventions. Indeed, the system described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A relief safety valve driving system that supplies a driving gas by use of a relief safety valve driving unit and thereby opens a relief safety valve provided in a main steam system of a nuclear power plant if an accident or a transient state occurs, for protecting a reactor against pressurization, wherein the relief safety valve driving unit opens the relief safety valve by supplying the driving gas to the relief safety valve by one or more auto-depressurization system actuating signals, among auto-depressurization system actuating signals respectively belonging to three safety segments, or by a relief valve functions actuating signal, and closes the relief safety valve without supplying the driving gas thereto when none of the auto-depressurization system actuating signals and the relief valve functions actuating signal is generated.

2. A relief safety valve driving system that supplies a driving gas through a driving gas supply line by use of a relief safety valve driving unit for auto-depressurization functions and thereby opens a relief safety valve provided in a main steam system of a nuclear power plant if an accident or a transient state occurs, for protecting a reactor against pressurization, wherein the relief safety valve driving unit for auto-depressurization functions comprises a plurality of solenoid valves for auto-depressurization functions respectively belonging to four safety segments, each solenoid valve for auto-depressurization functions being opened by an auto-depressurization system actuating signal belonging to a safety segment corresponding to the solenoid valve for auto-depressurization functions; wherein series-connected upstream and downstream solenoid valves for auto-depressurization functions are opened by two or more auto-depressurization system actuating signals, among the four auto-depressurization system actuating signals respectively belonging to the four safety segments, so as to supply a driving gas to the relief safety valve, thereby opening the relief safety valve; and wherein the series-connected upstream or downstream solenoid valve for auto-depressurization functions is closed for one or less than one auto-depressurization system actuating signal, so as not to supply the driving gas to the relief safety valve, thereby closing the relief safety valve.

3. The relief safety valve driving system according to claim 1, wherein the relief safety valve driving unit comprises three three-way solenoid valves for auto-depressurization functions respectively belonging to three safety segments, and one three-way solenoid valve for relief valve functions; wherein the respective three-way solenoid valves for auto-depressurization functions are excited by auto-depressurization system actuating signals belonging to safety segments corresponding to the respective three-way solenoid valves for auto-depressurization functions and the three-way solenoid valve for relief valve functions is excited by a relief valve functions actuating signal; wherein the three-way solenoid valves for auto-depressurization functions or the three-way solenoid valve for relief valve functions is excited by one or more auto-depressurization system actuating signals or by the relief valve functions actuating signal to supply the driving gas to the relief safety valve, thereby opening the relief safety valve; and wherein when none of the auto-depressurization system actuating signals and the relief valve functions actuating signal is generated, the three-way solenoid valves for auto-depressurization functions and the three-way solenoid valve for relief valve functions are not excited, so as not to supply the driving gas to the relief safety valve, thereby closing the relief safety valve.

4. The relief safety valve driving system according to claim 1, wherein the relief safety valve driving unit further comprises a malfunction preventing pipeline for releasing a driving gas leaking from solenoid valves constituting the relief safety valve driving unit into a reactor containment vessel to prevent the relief safety valve from false operation due to the leaked driving gas.

5. The relief safety valve driving system according to claim 2, wherein a malfunction preventing pipeline open into a reactor containment vessel is connected to part of the driving gas supply line downstream of the relief safety valve driving unit for auto-depressurization functions, so as to prevent the relief safety valve from false operation due to a driving gas leaking from the relief safety valve driving unit for auto-depressurization functions by the malfunction preventing pipeline.

6. The relief safety valve driving system according to claim 5, wherein an opening operation ensuring unit for auto-depressurization functions provided with solenoid valves for shutting off the malfunction preventing pipeline by any one of four auto-depressurization system actuating signals, so as to ensure opening operation of the relief safety valve, is disposed on the malfunction preventing pipeline.

7. The relief safety valve driving system according to claim 5, wherein an opening operation ensuring unit for auto-depressurization functions for maintaining the malfunction preventing pipeline in an open state for one or less than one auto-depressurization system actuating signal, among the four auto-depressurization system actuating signals, and shutting off the malfunction preventing pipeline by two or more auto-depressurization system actuating signals, so as to ensure opening operation of the relief safety valve, is disposed on the malfunction preventing pipeline.

8. The relief safety valve driving system according to claim 6 or 7, wherein a relief valve functions driving gas supply system for supplying the driving gas to the relief safety valve to open the relief safety valve is connected through a solenoid valve for relief valve functions to the malfunction preventing pipeline on which the opening operation ensuring unit for auto-depressurization functions is disposed.

9. The relief safety valve driving system according to claim 8, wherein the solenoid valve for relief valve functions is connected to part of the malfunction preventing pipeline downstream or upstream of the opening operation ensuring unit for auto-depressurization functions.
